(19) United States
(12) Patent Application Publication
(10) Pub. No.: US 2011/0242608 A1
(43) Pub. Date: Oct. 6, 2011

(54) IMAGE FORMING APPARATUS AND STORAGE CONTROL METHOD

(76) Inventors: Takayuki UCHIDA, Kanagawa (JP); Toshihiro Fujibayashi, Tokyo (JP); Hideto Nagae, Tokyo (JP)

(21) Appl. No.: 13/070,917

(22) Filed: Mar. 24, 2011

(30) Foreign Application Priority Data
Mar. 31, 2010 (JP) 2010-082452
Dec. 9, 2010 (JP) 2010-274975

(51) Int. Cl. G06F 15/00

(52) U.S. Cl. 358/1.16

(57) ABSTRACT

An image forming apparatus has a function for formation of an image and includes a first storage unit in which data is stored; an operation input receiving unit that receives an operation input from a user; a storage control unit that stores data in the first storage unit or an external storage device when the operation input receiving unit receives an operation input for storing the data, the external storage device being communicated with the image forming apparatus through a network; and a determining unit that performs, based on a predetermined condition, either a process of determining a storage destination of first data to be the external storage device or a process of determining a storage destination of second data to be the first storage unit, the first data being data stored in the first storage unit, the second data being data stored in the external storage device.

### CROSS-REFERENCE TO RELATED APPLICATIONS

The present application claims priority to and incorporates by reference the entire contents of Japanese Patent Application No. 2010-082452 filed in Japan on Mar. 31, 2010 and Japanese Patent Application No. 2010-274975 filed in Japan on Dec. 9, 2010.

### BACKGROUND OF THE INVENTION

1. Field of the Invention

The present invention relates to an image forming apparatus and a storage control method.

2. Description of the Related Art

For example, in an embedded apparatus having a computer system for implementing a specific function incorporated thereinto, such as an image forming apparatus, limitations in the storage area for storing data are more than those in an open system, such as a personal computer (PC). Therefore, there is a limitation in the amount of data that can be stored in the storage area. In recent years, an image forming apparatus provided with a web browser has been developed. When the image forming apparatus stores a snapshot of a web page, it is difficult to store the data of a desired web page due to a large amount of data of the web page and limitations in the capacity of the storage area. For example, when a large amount of image data is used in the web page, when a plurality of users stores the snapshot of the web page in the image forming apparatus, or when a specific user uses a large amount of data in the storage area, it is difficult to store a desired web page.

It is considered that an external storage unit for storing data is connected to the image forming apparatus. However, when the external storage unit is connected to each image forming apparatus, costs increase. Therefore, a technique has been developed in which a plurality of image forming apparatuses shares one image forming apparatus as an external storage device and stores image data in the image forming apparatus (for example, see Japanese Patent Application Laid-open No. 2002-135492).

However, in the technique disclosed in Japanese Patent Application Laid-open No. 2002-135492, since the entire image data is stored in one image forming apparatus, the image forming apparatus using the image data needs to communicate with the image forming apparatus, which is the storage destination of the image data, through a network and acquire the image data. Therefore, it is difficult to perform printing using the image data on demand.

### SUMMARY OF THE INVENTION

It is an object of the present invention to at least partially solve the problems in the conventional technology.

According to an aspect of the present invention, an image forming apparatus includes a service providing unit that provides a function related to formation of an image; a first storage unit in which data is stored; an operation input receiving unit that receives an operation input from a user; a storage control unit that stores data in the first storage unit or an external storage device when the operation input receiving unit receives an operation input for storing the data, the external storage device being communicated with the image forming apparatus through a network; and a determining unit that performs, based on a predetermined condition, at least one of a process of determining a storage destination of first data to be the external storage device and a process of determining a storage destination of second data to be the first storage unit, the first data being data stored in the first storage unit, the second data being data stored in the external storage device. The storage control unit stores the data in the storage destination determined by the determining unit.

According to another aspect of the present invention, a storage control method is performed in an image forming apparatus that is communicated with an external storage device through a network and has a function related to formation of an image incorporated. The storage control method includes storing, by a storage control unit of the image forming apparatus, data in a first storage unit of the image forming apparatus or the external storage device when an operation input receiving unit of the image forming apparatus receives an operation input to store the data; and performing, by a determining unit of the image forming apparatus, based on a predetermined condition, at least one of a process of determining a storage destination of first data to be the external storage device and a process of determining a storage destination of second data to be the first storage unit, the first data being data stored in the first storage unit, the second data being data stored in the external storage device, wherein the storing includes storing the data in the storage destination determined at the process.

According to still another aspect of the present invention, a computer-readable, non-transitory medium stores a storage control program causing a computer to execute the storage control method according to the present invention.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating the structure of an image forming system including an image forming apparatus according to a first embodiment;

FIG. 2 is a diagram illustrating the hardware configuration of an image forming apparatus 10;

FIG. 3 is a diagram illustrating the functional structure of the image forming apparatus 10;

FIG. 4 is a diagram illustrating a data reference table 44;

FIG. 5 is a flowchart illustrating the procedure of a web page storage process of the image forming apparatus 10;

FIG. 6 is a flowchart illustrating the detailed procedure of a process of determining the storage destination of the data newly created in Step S5 and storing the data in Step S7 of FIG. 5;

FIG. 7 is a flowchart illustrating the procedure of a process of deleting the stored data according to an operation input from the user;

FIG. 8 is a diagram illustrating the functional structure of an image forming apparatus 10 according to a second embodiment;

FIG. 9 is a diagram illustrating the data structure of communication management information; and

FIG. 10 is a flowchart illustrating the detailed procedure of the process of determining the storage destination of the data newly created in Step S5 and storing the data in Step S7 of FIG. 5.

### DETAILED DESCRIPTION OF THE PREFERRED EMBODIMENTS

Hereinafter, an image forming apparatus, a storage control method, and a storage control program according to exemplary embodiments of the invention will be described in detail with reference to the accompanying drawings.

### First Embodiment

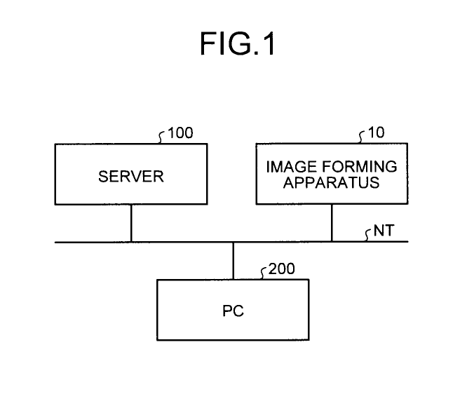

FIG. 1 is a diagram illustrating the structure of an image forming system including an image forming apparatus according to a first embodiment. The image forming system includes an image forming apparatus 10, a server 100, and a PC 200 which are connected to one another through a network NT. The network NT is, for example, a local area network (LAN), an intranet, Ethernet (registered trademark), or Internet. The server 100 or the PC 200 functions as an external storage device that stores data of the image forming apparatus 10.

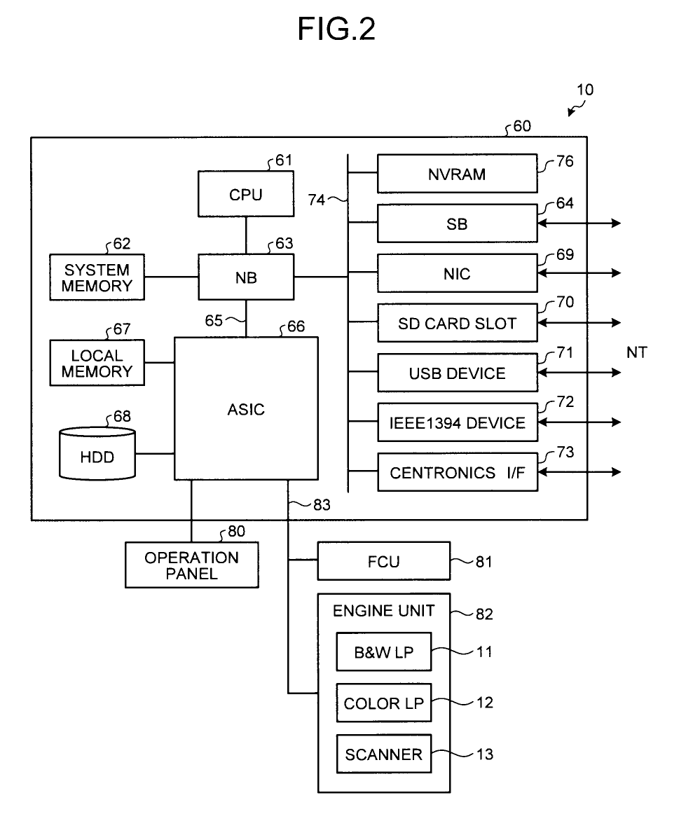

FIG. 2 is a diagram illustrating the hardware configuration of the image forming apparatus 10 according to this embodiment. The image forming apparatus 10 includes a controller 60, an operation panel 80, an FCU 81, and an engine unit 82. The controller 60 includes a CPU 61, a system memory 62, a northbridge (NB) 63, a southbridge (SB) 64, an ASIC 66, a local memory 67, an HDD 68, a network interface card (NIC) 69, an SD card slot 70, a USB device 71, an IEEE1394 device 72, a Centronics interface 73, and an NVRAM 76.

The operation panel 80 is connected to the ASIC 66 of the controller 60. The FCU 81 and the engine unit 82 are connected to the ASIC 66 of the controller 60 through a PCI bus 83. In the controller 60, for example, the local memory 67 and the HDD 68 are connected to the ASIC 66, and the CPU 61 and the ASIC 66 are connected to each other through the NB 63 of a CPU chipset. Since the CPU 61 and the ASIC 66 are connected to each other through the NB 63, the controller 60 corresponds to a case in which the interface of the CPU 61 is not opened to the public. The ASIC 66 and the NB 63 are connected to each other through an accelerated graphics port (AGP) 65.

The NB 63 is a bridge for connecting the CPU 61, the system memory 62, the SB 64, the ASIC 66, the NIC 69, the SD card slot 70, the USB device 71, the IEEE1394 device 72, and the Centronics interface 73. The SB 64, the NIC 69, the SD card slot 70, the USB device 71, the IEEE1394 device 72, and the Centronics interface 73 are connected to the NB 63 through a PCI bus 74. The SB 64 is a bridge for connecting the PCI bus 74, a ROM (not shown), and peripheral devices.

The CPU 61 reads various kinds of software stored in the ROM or the HDD 68 connected to the SB 64 and executes the read software, controls the overall operation of the image forming apparatus 10, and implements various kinds of functions. The CPU 61 has a timer function of clocking the time. The system memory 62 is used as, for example, an image forming memory of the image forming apparatus 10 or a page buffer that temporarily stores data indicating a web page. The local memory 67 is used as an image buffer for copy or a code buffer.

The ASIC 66 is an IC only for image processing which has an image processing hardware component. The HDD 68 is an auxiliary storage device that stores, for example, image data, text data, various kinds of software, and a font data form. The NIC 69 is an interface that connects the image forming apparatus 10 to the network NT. An SD card can be inserted into or removed from the SD card slot 70. The SD card slot 70 performs an interruption corresponding to the insertion or removal of the SD card on the CPU 61. The USB device 71, the IEEE1394 device 72, and the Centronics interface 73 are interfaces based on their standards. The NVRAM 76 stores various kinds of software or various kinds of data when the CPU 61 executes various kinds of software.

The operation panel 80 receives an operation input from the user and displays information to the user. The engine unit 82 includes a black-and-white laser printer (B&W LP) 11, a color laser printer (Color LP) 12, and a scanner 13 which serve as image forming units that form images. The FCU 81 controls facsimile communication.

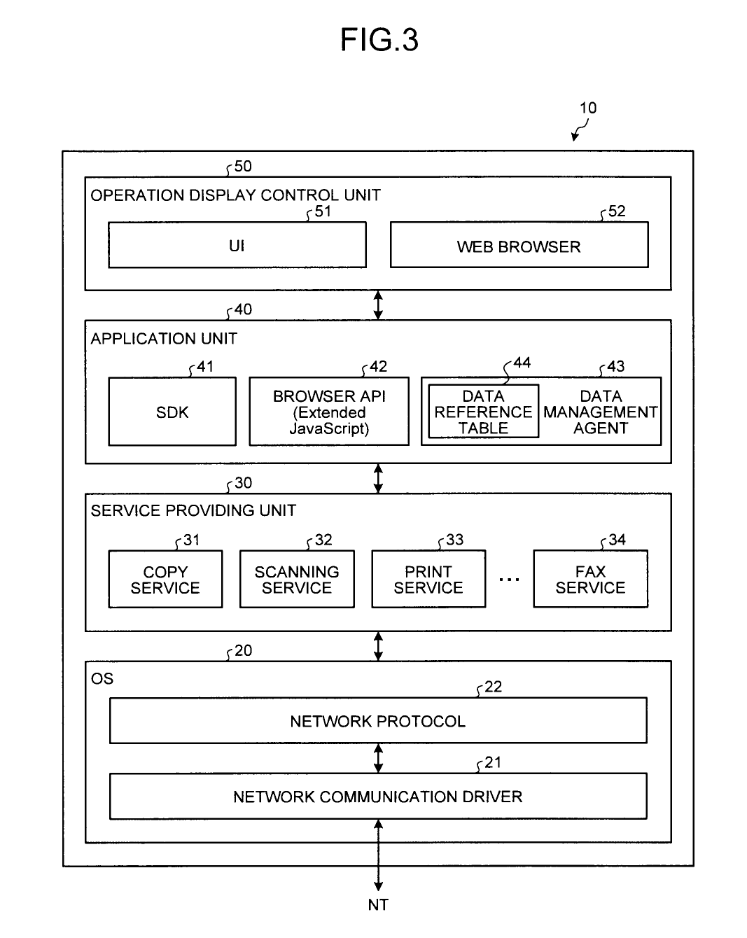

FIG. 3 is a diagram illustrating the functional structure of the image forming apparatus 10. The image forming apparatus 10 includes an operating system (OS) 20, a service providing unit 30, an application unit 40, and an operation display control unit 50, which are various kinds of software stored in the ROM or the HDD 68. The CPU 61 reads and executes the various kinds of software to perform the functions of the OS 20, the service providing unit 30, the application unit 40, and the operation display control unit 50.

For example, the OS 20 controls the implementation of various kinds of basic functions of the image forming apparatus 10 and includes a network communication driver 21 and a network protocol 22. The network communication driver 21 controls communication through the network NT. The network communication driver 21 receives data to be transmitted through the network NT from the network protocol 22 or transmits data received through the network NT to the network protocol 22. The network protocol 22 converts an instruction from the operation display control unit 50 or data transmitted from the service providing unit 30 into data of a format suitable for the network NT and transmits the data to the network communication driver 21, or converts data received by the network communication driver 21 through the network NT into data that can be used by software and transmits the data to the service providing unit 30 or the operation display control unit 50. According to this structure, when receiving an instruct to receive data indicating a web page whose Uniform Resource Locator (URL) is designated from a web browser 52, which will be described below, the OS 20 accesses the designated URL and receives the data indicating the web page stored in the URL, in response to the instruction.

The service providing unit 30 provides functions related to the formation of images, such as the functions of a printer, a copier, a facsimile, and a scanner, and performs image forming processes peculiar to the functions. The service providing unit 30 includes a copy service 31, which is copy software, a scanning service 32, which is scanner software, a print service 33, which is printer software having a page description language (PDL or PCL) and a postscript (PS), and a FAX service 34, which is facsimile software.

The operation display control unit 50 controls an operation input from the user through the operation panel 80 or the display of information. The operation display control unit 50 includes a User Interface (UI) 51 and the web browser 52. The UI 51 receives an operation input from the user through the operation panel 80 and outputs an instruction to the web browser 52 or a data management agent 43 or display information on the operation panel 80 according to the operation input. The web browser 52 is software for displaying a web page on the operation panel 80. Specifically, when an operation input to designate a Uniform Resource Locator (URL) is received through the operation panel 80 and an instruction to display a web page stored in the URL is input from the UI 51, the web browser 52 instructs the OS 20 to receive data indicating the web page, and the OS 20 displays the web page whose data has been received on the operation panel 80 in response to the instruction. The data indicating the web page received by the OS 20 is temporarily stored in, for example, the page buffer of the system memory 62. The data is used and the web page is displayed on the operation panel 80. When the UI 51 receives an operation input to store the web page displayed on the operation panel 80 through the operation panel 80, the web browser 52 designates the web page and instructs the data management agent 43 to store the web page.

The application unit 40 includes a Software Development Kit (SDK) 41, a browser Application Program Interface (API) 42, and the data management agent 43. The SDK 41 is a kit for a software developer that is composed of, for example, a library, various kinds of samples, tools, and documents required to develop software. The browser API 42 is a set of commands or functions used in the web browser 52.

The data management agent 43 includes a data reference table 44, manages the amount of data that can be newly stored in a storage area of the image forming apparatus 10 which will be the storage destination of the data indicating the web page, controls the storage of the data indicating the web page according to the operation input received from the user to the UI 51 through the operation panel 80, and stores the data (hereinafter, referred to as stored data) in the image forming apparatus 10 or an external storage device of the image forming apparatus 10. The external storage device is, for example, the server 100 or the PC 200. In this case, the data management agent 43 appropriately determines the storage destination of the data stored in the image forming apparatus 10 to be the external storage device according to predetermined condition and moves the stored data whose storage destination is determined to be the external storage device to the external storage device, or appropriately determines the storage destination of the data stored in the image forming apparatus 10 to be the external storage device and moves the stored data whose storage destination is determined to be the external storage device to the external storage device.

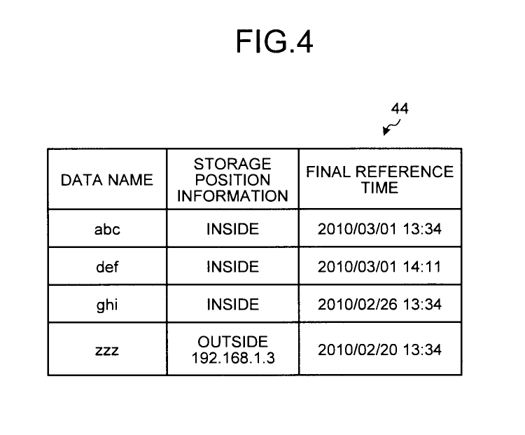

Specifically, when an instruction to store the designated web page is received from the web browser 52, the data management agent 43 creates data (stored data), which is a snapshot of the web page using the data indicating the web page stored in the page buffer of the system memory 62, and creates records of the data reference table 44 for the stored data. The snapshot of the web page is the image of the web page extracted at specific timing. FIG. 4 is a diagram illustrating an example of the data reference table 44. In FIG. 4, the data reference table 44 includes a data name for identifying the stored data, storage position information indicating the storage destination of data, and the final reference time which is the usage situation of the stored data and indicates the time when the stored data is used for display. The storage destination of the data is, for example, the HDD 68 of the image forming apparatus 10 or an external storage device of the image forming apparatus 10. When the storage destination of the data is the external storage device, the storage position information is, for example, the IP address of the external storage device. At the beginning of the creation of data, storage destination information indicates the image forming apparatus 10 as the storage destination of the data.

When data is newly created, the data management agent 43 appropriately moves the data stored in the image forming apparatus 10 to the external storage device according to the amount of data that can be newly stored in the storage area of the image forming apparatus 10 which will be the storage destination of the data, with reference to the data reference table 44 and stores new data in the image forming apparatus 10. In this case, the data management agent 43 appropriately determines the storage destination of the data to be the external storage device according to the usage situation of the data stored in the image forming apparatus 10 and appropriately moves the stored data to the external storage device. When the data is moved, the data management agent 43 updates the storage destination information of the data in the data reference table 44. Whenever an instruction to display the web page indicated by the stored data is input, the data management agent 43 acquires data from the storage destination with reference to the data reference table 44, transmits the acquired data to the web browser 52, and updates the time when the data is acquired as the final reference time when the data is used for display in the data reference table 44.

When an instruction to delete the stored data is received from the UI 51 according to an operation input from the user through the operation panel 80, the data management agent 43 deletes the stored data from the storage destination with reference to the data reference table 44, and appropriately moves other data stored in the external storage device to the image forming apparatus 10 according to whether the storage destination of the data is the image forming apparatus 10 or the external storage device and whether there are other stored data in the external storage device. When the storage destination of the deleted data is the image forming apparatus 10, the amount of data that can be newly stored in the storage area of the image forming apparatus 10 which will be the storage destination of the stored data increases. In this case, the data management agent 43 appropriately determines the storage destination of the data to be the image forming apparatus 10 according to the usage situation of the data stored in the external storage device, and appropriately moves the stored data to the image forming apparatus 10. Then, the data management agent 43 updates the storage position information indicating the storage destination of the moved data in the data reference table 44.

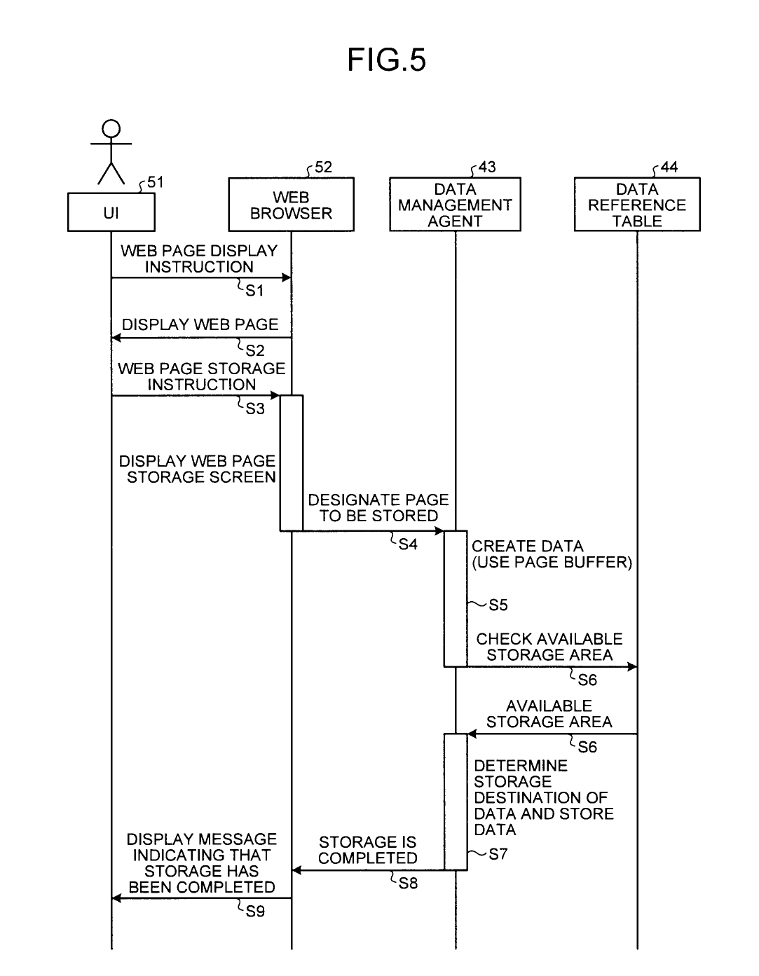

Next, the procedure of a web page storage process of the image forming apparatus 10 according to this embodiment will be described with reference to FIG. 5. When the user operates the operation panel of the image forming apparatus 10 to input an instruction to designate the URL of the web page that the user wants to refer to, the UI 51 receives the operation input (Step S1), and the web browser 52 instructs the OS 20 to receive data indicating the web page stored in the URL designated by the operation input. Then, the OS 20 receives the data in response to the instruction and displays the web page on the operation panel 80 (Step S2). When the user inputs an instruction to store the web page to the operation panel of the image forming apparatus 10, the UI 51 receives the operation input (Step S3), and the web browser 52 designates the web page and instructs the data management agent 43 to store the web page, according to the operation input (Step S4). For example, the URL of the web page to be stored is designated. When receiving an instruction to store the designated web page from the web browser 52, the data management agent 43 creates data (stored data), which is a snapshot of the web page, using the data indicating the web page stored in the page buffer of the system memory 62 (Step S5). Then, the data management agent 43 creates the record of the data reference table 44 for the stored data. However, the storage destination information of the record indicates the image forming apparatus 10 as the storage destination of the data, and the final reference time indicates the time when the data is created.

Then, the data management agent 43 determines the amount of data that can be newly stored in the storage area of the image forming apparatus 10 with reference to the data reference table 44 (Step S6). The data management agent 43 appropriately moves the data stored in the image forming apparatus 10 to the external storage device according to the amount of data and stores new data in the image forming apparatus 10 (Step S7). However, after the stored data is moved, the data management agent 43 updates the storage destination information of data in the data reference table 44. Then, the data management agent 43 notifies the web browser 52 that the storage of the designated web page has been completed (Step S8). The web browser 52 receives the notification and displays a message indicating that the storage of the designated web page has been completed on the operation panel 80 (Step S9).

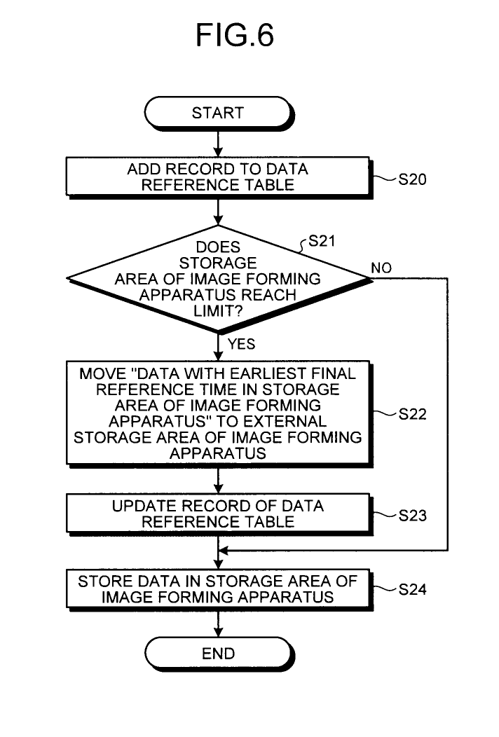

The detailed procedure of the process of determining the storage destination of the data newly created in Step S5 and storing the data in Step S7 will be described with reference to FIG. 6. In Step S20, as described above, the data management agent 43 creates the record of the newly created data and adds the record to the data reference table 44. Then, the data management agent 43 determines whether the amount of data that can be newly stored in the storage area of the image forming apparatus 10 which will be the storage destination of the data reaches a limit, with reference to the data reference table 44 (Step S21). For example, the upper limit of the amount of data that can be newly stored in the storage area of the image forming apparatus 10 which will be the storage destination of the data is predetermined, and the data management agent 43 determines whether the amount of data that is indicated by the storage position information stored in the data reference table 44 to be stored in the image forming apparatus 10 reaches the upper limit, thereby determining whether the amount of data reaches a limit. When the determination result in Step S21 is “No”, the data management agent 43 stores the data newly created in Step S5 in the HDD 68 of the image forming apparatus 10 (Step S24). On the other hand, when the determination result in Step S21 is “Yes,” the data management agent 43 determines the storage destination of the data with the earliest final reference time in the data reference table 44 to be the external storage device and determines to move the data to the external storage device. That is, the data management agent 43 determines the storage destination of data that is less likely to be used than other data stored in the image forming apparatus 10 to be the external storage device. The data management agent 43 transmits the data to the external storage device through the OS 20 and stores the data in the external storage device (Step S22). Then, the data management agent 43 updates the storage position information indicating the storage destination of the data in the data reference table 44 (Step S23). For example, in the example shown in FIG. 4, data with a data name “ghi” is moved to the external storage device and the storage position information is updated in the data reference table 44 such that the storage destination indicates the IP address of the external storage device (the server 100 or the PC 200). Then, the process proceeds to Step S24 and the data newly created in Step S5 is stored in the HDD 68 of the image forming apparatus 10, as described above.

Next, the usage of the data will be described. For example, the UI 51 displays a screen indicating a list of the data names of the data stored in the image forming apparatus 10 or the external storage device on the operation panel 80. When the user uses the operation panel 80 to select the data name and input an instruction to display data with the selected data name, the UI 51 receives the operation input and instructs the Web browser 52 to display the web page. The web browser 52 determines the storage destination of the data through the data management agent 43 and acquires the data from the storage destination. For example, when the storage destination is the image forming apparatus 10, the web browser 52 reads and acquires data from the HDD 68 of the image forming apparatus 10 and displays the web page on the operation panel 80 through the UI 51. When the storage destination is the external storage device, the web browser 52 receives and acquires data from the external storage device through the network NT and the OS 20 and displays the Web page indicated by the data on the operation panel 80 through the UI 51. Then, the web browser 52 updates the time when the data is acquired as the final reference time when the data is used for display in the data reference table 44 through the data management agent 43. The server 100 or the PC 200, which is an external storage device, can use data stored therein. For example, the server 100 or the PC 200 can display the web page indicated by the stored data on a display unit connected thereto, instruct the image forming apparatus 10 to print the web page indicated by the stored data, or edit the stored data.

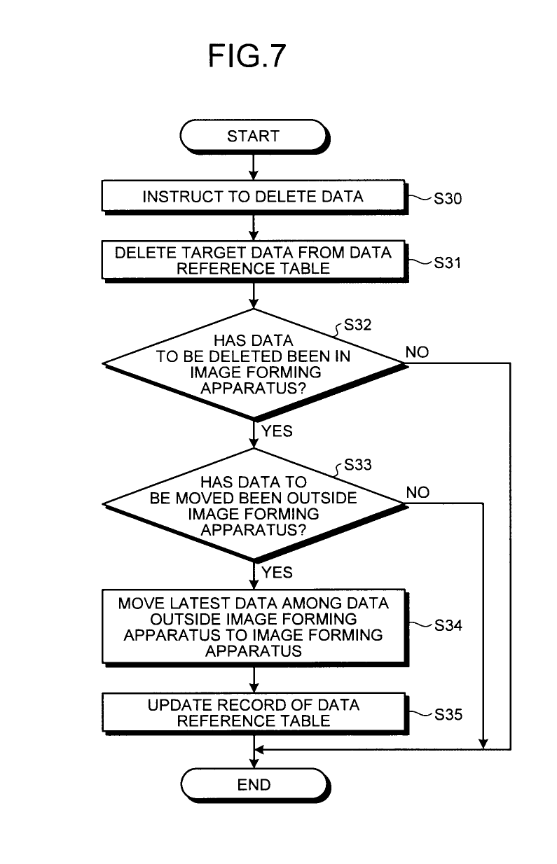

Next, the procedure of a process of deleting the previously stored data in response to an operation input from the user will be described with reference to FIG. 7. For example, when the UI 51 displays a screen indicating a list of the data names of the stored data on the operation panel 80 and the user uses the operation panel 80 to select the data name and input an instruction to delete the stored data with the selected data name, the UI 51 receives the operation input (Step S30) and instructs the data management agent 43 to delete the stored data with the selected data name. The data management agent 43 refers to the storage position information stored in the data reference table 44, deletes the stored data corresponding to the selected data name from the storage destination indicated by the storage destination information, and deletes the record of the stored data from the data reference table 44, in response to the deletion instruction (Step S31). Then, the data management agent 43 determines whether the storage destination of the data indicated by the storage position information referred to delete the record of the stored data is the image forming apparatus 10 (Step S32). When the determination result in Step S32 is “No,” the data management agent 43 ends the process. When the determination result in Step S32 is “Yes,” the stored data is deleted, and the amount of data that can be newly stored in the storage area of the image forming apparatus 10 increases. Therefore, other data stored in the external storage device can be stored in the storage area of the image forming apparatus 10. Therefore, the data management agent 43 determines whether there is data stored in the external storage device, which is the storage destination indicated by the storage position information, with reference to the data reference table 44 in order to determine whether there is the stored data to be moved to the image forming apparatus 10 (Step S33). When the determination result in Step S33 is “No,” the data management agent 43 ends the process. When the determination result in Step S33 is “Yes,” the data management agent 43 determines the storage destination of data with the latest final reference time among the data items stored in the external storage device, which is the data storage destination indicated by the storage position information, to be the image forming apparatus 10 with reference to the data reference table 44 and determines to move the stored data to the image forming apparatus 10. That is, the data management agent 43 determines the storage destination of the data having a high availability (in other words, more likely to be used than other data stored) in the external storage device to be the external storage device. The data management agent 43 receives the data from the external storage device through the OS 20 and stores the received data in the HDD 68 of the image forming apparatus 10 (Step S34). Then, the data management agent 43 updates the storage position information indicating the storage destination of data in the data reference table 44 (Step S35). For example, in the example shown in FIG. 4, when the stored data with a data name “abc” is deleted, the stored data with a data name “zzz” is moved from the external storage device to the image forming apparatus 10 and the storage position information is updated in the data reference table 44 such that the storage destination is the image forming apparatus 10.

As described above, the image forming apparatus 10 stores data (stored data) indicating the web page so as to be distributed inside and outside the image forming apparatus 10. In this case, the image forming apparatus 10 stores data with the latest final reference time, which is the time when the data is used for display, in the image forming apparatus 10 according to the usage situation of the data. Therefore, it is possible to achieve an effective access to the stored data that is likely to be used by the user. The data stored in the image forming apparatus 10 can be accessed at a speed higher than the data stored in the external storage device of the image forming apparatus 10. Therefore, it is possible to directly use the data stored in the image forming apparatus 10, if needed. For example, it is possible to perform printing with the stored data using the function of the print service 33. In addition, the image forming apparatus 10 appropriately moves the stored data with the earliest final reference time as stored data that is less likely to be used by the user to the external storage device of the image forming apparatus 10, according to the amount of data that can be newly stored in the storage area of the image forming apparatus 10. In this way, it is possible to store data without the user being aware of the limit of the capacity of the storage area of the image forming apparatus 10.

When storing a web page, the image forming apparatus 10 creates data, using the page buffer that temporarily stores the web page stored data. In this way, it is possible to reduce the amount of data. Therefore, it is possible to increase the maximum amount of data that can be stored in the image forming apparatus 10.

### Second Embodiment

Next, an image forming apparatus, a storage control method, and a storage control program according to a second embodiment will be described. The same components as those in the first embodiment are denoted by the same reference numerals and a description thereof will not be repeated.

In this embodiment, when a plurality of external storage devices, such as servers 100 or PCs 200, is connected to the image forming system through the network NT and data is stored in the external storage devices, the image forming apparatus 10 selects an external storage device that is most suitable to store the data from the plurality of external storage devices.

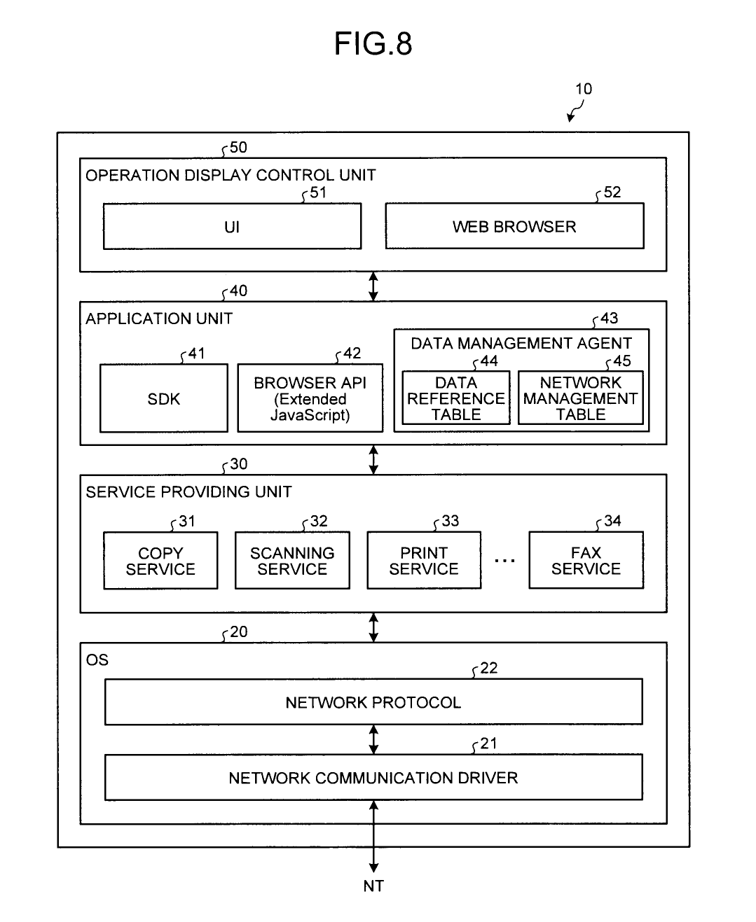

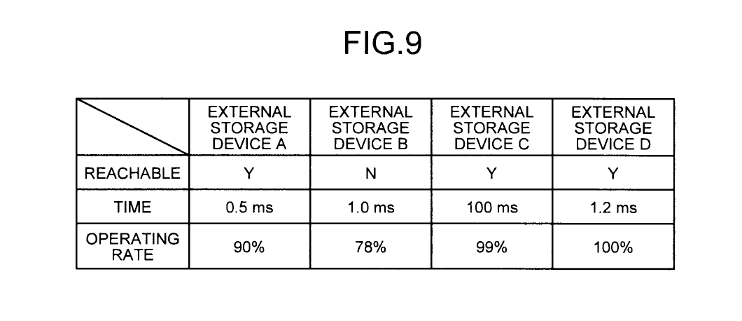

FIG. 8 is a diagram illustrating the functional structure of the image forming apparatus 10 according to this embodiment. In this embodiment, a data management agent 43 includes a network management table 45 in addition to the data reference table 44. The network management table 45 stores communication management information related to the reachability of communication through the network NT for each of the external storage devices, such as the servers 100 or the PCs 200 connected to the image forming system through the network NT. FIG. 9 is a diagram illustrating the data structure of the communication management information. In this embodiment, it is assumed that four external storage devices are connected to the image forming system and are referred to as external storage devices A, B, C, and D for discrimination. However, it is assumed that the IP addresses of the external storage devices A, B, C, and D are stored in, for example, the HDD 68 in advance.

The communication management information indicates whether the network is reachable (Y/N), the response time (time) when the network is reachable, and the percentage (operating rate) of the network that is reachable for each of the external storage devices A, B, C, and D. For determination whether the network is reachable, the data management agent 43 periodically transmits a ping to each of the external storage devices A, B, C, and D through the network protocol 22 and the network communication driver 21 and determines whether there is a response to the ping, thereby detecting whether communication is available (reachable). The data management agent 43 determines that the network is reachable (Y) when there is a response, and determines that the network is not reachable (N) when there is no response. Whenever the detection is performed, the data management agent 43 stores the detection result in the communication management information. The response time when the network is reachable is the average of the time from the transmission of the ping to the return of the response. Whenever a response to the ping is received through the network protocol 22 and the network communication driver 21, the data management agent 43 calculates the response time and stores the calculated value in the communication management information. For the operating rate, whenever the ping is transmitted, the data management agent 43 calculates the number of times a response to the ping is received with respect to the number of times the ping is transmitted and stores the ratio as the operating rate in the communication management information.

The data management agent 43 moves the stored data whose storage destination has been determined to be the external storage device to the external storage device, or appropriately determines the storage destination of the data stored in the image forming apparatus 10 to be the external storage device and moves the stored data whose storage destination has been determined to be the external storage device to the external storage device, according to predetermined conditions. In this case, when the storage destination of the data stored in the image forming apparatus 10 is determined to be the external storage device and a plurality of external storage devices is connected to the image forming system, the data management agent 43 selects the external storage device with the highest reachability in communication through the network NT as an external storage device that is most suitable to store the data with reference to the network management table 45, and moves the data whose storage destination has been determined to be the external storage device to the selected external storage device.

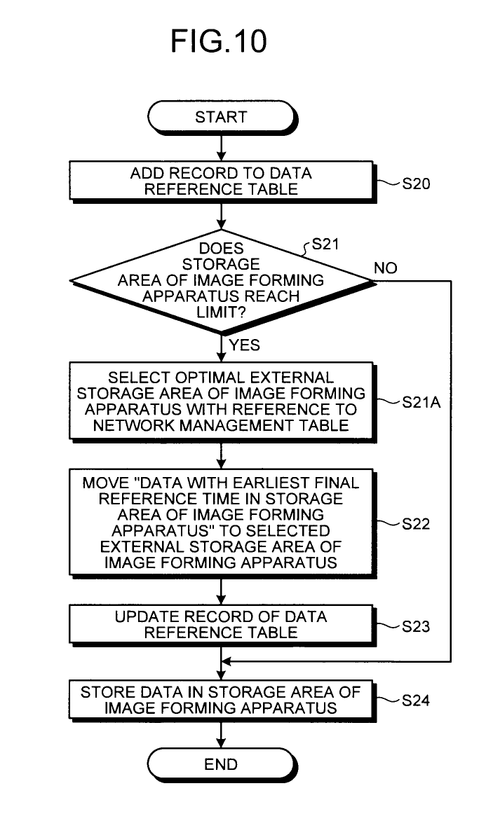

Next, the procedure of a web page storage process of the image forming apparatus 10 according to this embodiment will be described. The process is the same as that shown in FIG. 5 and thus a detailed description thereof will not be repeated. In this embodiment, the detailed procedure of the process of determining the storage destination of the data newly created in Step S5 and storing the data in Step S7 will be described with reference to FIG. 10. Steps S20 and S21 are the same as those in the first embodiment. In Step S21A, the data management agent 43 selects the external storage device that is most suitable to store data with reference to the network management table 45. Specifically, the data management agent 43 selects the external storage device with the highest operating rate indicated by the communication management information stored in the network management table 45 as the optimal external storage device. In this case, when there is a plurality of external storage devices with the same operating rate, the data management agent 43 selects the external storage device with the shortest response time indicated by the communication management information as the optimal external storage device. For example, in the example shown in FIG. 9, the external storage device is selected as the optimal external storage device. Then, in Step S22, by the same method as that in the first embodiment, the data management agent 43 determines the storage destination of the data with the earliest final reference time in the data reference table 44 to be the external storage device and determines to move the data to the external storage device. Then, the data management agent 43 transmits the stored data to the external storage device selected in Step S21A through the OS 20 and stores the data in the external storage device. Step S23 and S24 are the same as those in the first embodiment.

According to the above-mentioned structure, when storing the data in the external storage device of the image forming apparatus 10, the image forming apparatus 10 stores the data in the external storage device with the highest reachability in communication through the network NT. Therefore, it is possible to improve the use convenience of data stored outside the image forming apparatus 10.

### Modifications

The invention is not limited to the above-described embodiments, and the components may be changed without departing from the scope and spirit of the invention. In addition, a plurality of components according to the above-described embodiments may be appropriately combined with each other to form various kinds of structures. For example, some of the components according to the above-described embodiments may be removed. In addition, the components according to different embodiments may be appropriately combined with each other. The following various kinds of modifications can be made.

In the above-described embodiments, various kinds of programs executed by the image forming apparatus 10 may be stored in a computer connected to a network, such as the Intranet, downloaded from the network, and then provided. The various kinds of programs may be stored as files with an installable format or an executable format on a computer-readable recording medium, such as a CD-ROM, a flexible disk (FD), a CD-R, or a digital versatile disk (DVD) and then provided.

In each of the above-described embodiments, the image forming apparatus 10 is applied to a multi-function machine having the copy function, the print function, the scanning function, and the facsimile function, but the invention is not limited thereto. For example, the invention may be applied to image forming apparatuses having at least one of these functions.

In each of the above-described embodiments, the data management agent 43 treats the final reference time as the usage situation of the stored data and stores the final reference time in the data reference table 44. However, the invention is not limited thereto. For example, the data management agent 43 may treat the number of times (hereinafter, referred to as the number of times the stored data is referred to) the stored data is used for display as the usage situation of the stored data and may store the number of times in the data reference table 44. In Step S22 of FIG. 6, the data management agent 43 may determine to move, to the external storage device, the stored data that is least frequently referred to. In addition, in Step S34 shown in FIG. 7, the data management agent 43 may determine to move, to the image forming apparatus 10, the stored data that is most frequently referred to.

In each of the above-described embodiments, the initial storage destination of the newly created data is the image forming apparatus 10, but the invention is not limited thereto. The image forming apparatus 10 may determine the initial storage destination of the newly created data to be the image forming apparatus 10 or the external storage device according to predetermined conditions.

In each of the above-described embodiments, the web page is stored as data in the image forming apparatus 10 or the external storage device, but the invention is not limited thereto.

In the second embodiment, the data management agent 43 includes the network management table 45 separately from the data reference table 44, but the invention is not limited thereto. The data reference table 44 and the network management table 45 may be integrally formed.

According to the above-mentioned aspects of the invention, it is possible to store data without the user being aware of limitations in the capacity of a storage area and effectively access the stored data.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus, comprising:
a service providing unit that provides a function related to formation of an image;
a first storage unit in which data is stored;
an operation input receiving unit that receives an operation input from a user;
a storage control unit that stores data in the first storage unit or an external storage device when the operation input receiving unit receives an operation input for storing the data, the external storage device being communicated with the image forming apparatus through a network; and
a determining unit that performs, based on a predetermined condition, at least one of a process of determining a storage destination of first data to be the external storage device and a process of determining a storage destination of second data to be the first storage unit, the first data being data stored in the first storage unit, the second data being data stored in the external storage device,
wherein the storage control unit stores the data in the storage destination determined by the determining unit.

2. The image forming apparatus according to claim 1, further comprising:
a page buffer that stores data indicating a web page; and
a creating unit that creates data to be stored using the data stored in the page buffer when the operation input receiving unit receives an operation input to store the data,
wherein the storage control unit stores the data created by the creating unit in the first storage unit or the external storage device.

3. The image forming apparatus according to claim 1,
wherein the determining unit performs, based on a usage of at least one of the first data and the second data by the user, at least one of the process of determining the storage destination of the first data to be the external storage device and the process of determining the storage destination of the second data to be the first storage unit.

4. The image forming apparatus according to claim 3,
wherein the determining unit determines a storage destination of third data to be the first storage unit based on an amount of data that the first storage unit allows to store newly, the third data having a high availability among the second data, and
the storage control unit acquires the third data from the external storage device through the network and stores the acquired third data in the first storage unit.

5. The image forming apparatus according to claim 3,
wherein the determining unit determines a storage destination of fourth data to be the external storage device based on an amount of data that the first storage unit allows to store newly, the fourth data having a high availability among the first data, and
the storage control unit acquires the fourth data from the first storage unit and stores the acquired fourth data in the external storage device through the network.

6. The image forming apparatus according to claim 3, further comprising:
a second storage unit that stores reference information and the usage of data, the reference information indicating whether the storage destination of the data is the first storage unit or the external storage device; and
a management unit that stores the reference information in the second storage unit or updates the storage destination and the usage of data indicated by the reference information stored in the second storage unit when the storage control unit stores the data in the first storage unit or the external storage device.

7. The image forming apparatus according to claim 6,
wherein, when the operation input receiving unit receives an operation input to delete fifth data stored in the first storage unit, the determining unit determines a storage destination of third data to be the first storage unit based on the usage of data indicated by the reference information, the third data having a high availability among the second data whose storage destination is the external storage device,
the storage control unit deletes the fifth data from the first storage unit, acquires the third data from the external storage device through the network, and stores the acquired third data in the first storage unit, and
the management unit deletes the reference information about the fifth data from the second storage unit and updates the reference information so as to indicate that the storage destination of the third data has been changed from the external storage device to the first storage unit.

8. The image forming apparatus according to claim 6,
wherein, when the operation input receiving unit receives an operation input to store the data, the determining unit determines a storage destination of fourth data to be the external storage device based on the usage of data indicated by the reference information, the fourth data having a high availability among the first data whose storage destination is the first storage unit,
the storage control unit stores the data in the first storage unit, acquires the fourth data from the first storage unit, and stores the acquired fourth data in the external storage device through the network, and
the management unit stores the reference information so as to indicate that the storage destination of the data is the first storage unit and updates the reference information so as to indicate that the storage destination of the fourth data has been changed from the first storage unit to the external storage device.

9. The image forming apparatus according to claim 1, further comprising:
a selection unit that selects the external storage device as the storage destination from a plurality of external storage devices when the image forming apparatus allows communication with the plurality of external storage devices through the network and the determining unit determines the storage destination to be the external storage device.

10. The image forming apparatus according to claim 9,
wherein, when the image forming apparatus allows communication with the plurality of external storage devices through the network and the determining unit determines the storage destination to be the external storage device, the selection unit selects, as the storage destination, the external storage device having a highest reachability in communication through the network among the plurality of external storage devices.

11. A storage control method, performed in an image forming apparatus that is communicated with an external storage device through a network and has a function related to formation of an image incorporated, the storage control method comprising:
storing, by a storage control unit of the image forming apparatus, data in a first storage unit of the image forming apparatus or the external storage device when an operation input receiving unit of the image forming apparatus receives an operation input to store the data; and
performing, by a determining unit of the image forming apparatus, based on a predetermined condition, at least one of a process of determining a storage destination of first data to be the external storage device and a process of determining a storage destination of second data to be the first storage unit, the first data being data stored in the first storage unit, the second data being data stored in the external storage device,
wherein the storing includes storing the data in the storage destination determined at the process.

12. A computer-readable, non-transitory medium storing a storage control program causing a computer included in an image forming apparatus that is communicated with an external storage device through a network and has a function related to formation of an image to execute:
storing, by a storage control unit of the image forming apparatus, data in a first storage unit of the image forming apparatus or the external storage device when an operation input receiving unit of the image forming apparatus receives an operation input to store the data; and
performing, by a determining unit of the image forming apparatus, based on a predetermined condition, at least one of a process of determining a storage destination of first data to be the external storage device and a process of determining a storage destination of second data to be the first storage unit, the first data being data stored in the first storage unit, the second data being data stored in the external storage device,
wherein the storing includes storing the data in the storage destination determined at the process.
